(19) United States
(12) Patent Application Publication
(10) Pub. No.: US 2026/0001158 A1
(43) Pub. Date: Jan. 1, 2026

(54) WELDING HORN AND WELDING DEVICE FOR SECONDARY BATTERY

(71) Applicant: SAMSUNG SDI CO., LTD., Yongin-Si Gyeonggi-do (KR)

(72) Inventors: Yejin SEO, Yongin-Si (KR); Donghyun KIM, Yongin-Si (KR); Eunjeong MOON, Yongin-Si (KR)

(21) Appl. No.: 19/073,848

(22) Filed: Mar. 7, 2025

(30) Foreign Application Priority Data
Jun. 28, 2024 (KR) 10-2024-0085791

(51) Int. Cl. B23K 20/10; H01M 50/536

(52) U.S. Cl. CPC B23K 20/106; H01M 50/536

(57) ABSTRACT

A welding horn includes a body portion extending in a first direction; and an extension portion extending in a second direction crossing the first direction from an end of the body portion, and is configured to pressurize a welding object connected to an electrode assembly, the extension portion including a lower surface facing the welding object; a first corner portion connected to one end of the lower surface and facing the electrode assembly; a first side surface extending from the first corner portion to the body portion; and a tip portion protruding from the lower surface and contacting the welding object, the tip portion being offset from a center of the lower surface toward the first corner portion.

### CROSS-REFERENCE TO RELATED APPLICATION

The present application claims priority to and the benefit of Korean Application No. 10-2024-0085791, filed on Jun. 28, 2024, in the Korean Intellectual Property Office, the entire disclosure of which is incorporated herein by reference.

### BACKGROUND

### 1. Field

Aspects of the present invention relate to a welding horn and a welding device which are applied in manufacturing secondary batteries.

### 2. Description Of The Related Art

Unlike primary batteries that are not designed to be (re) charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

Recently, a large number of customers want lightweight secondary batteries for use in portable IT devices, automobiles, etc. In the past, methods have been devised to make the materials used in secondary batteries, such as substrates, separators, and outer materials even thinner to reduce the weight of the battery, or to improve the properties of active materials to increase energy density. However, when applying these methods, there is a problem that the safety of the secondary batteries may diminish. Accordingly, efforts to reduce dead space within the battery are ongoing.

The above information disclosed in this Background section is for enhancement of understanding of the background of the present disclosure, and therefore, it may contain information that does not constitute related (or prior) art.

### SUMMARY

Aspects of embodiments of the present disclosure are directed to a welding horn and welding device for a secondary battery to address the above-mentioned problems.

These and other aspects and features of the present disclosure will be described in or will be apparent from the following description of embodiments of the present disclosure.

According to some embodiments of the present disclosure, there is provided a welding horn including: a body portion extending in a first direction; and an extension portion extending in a second direction crossing the first direction from an end of the body portion, and is configured to pressurize a welding object connected to an electrode assembly, the extension portion including: a lower surface facing the welding object; a first corner portion connected to one end of the lower surface and facing the electrode assembly; a first side surface extending from the first corner portion to the body portion; and a tip portion protruding from the lower surface and contacting the welding object, the tip portion being offset from a center of the lower surface toward the first corner portion.

In some embodiments, the first corner portion is in a form of a curved surface having a curvature.

In some embodiments, a radius of the curvature of the first corner portion is 0.1 mm to 0.5 mm.

In some embodiments, the tip portion is positioned to be in contact with the first corner portion.

In some embodiments, the tip portion is spaced from the first side surface by 0.1 mm to 0.5 mm, based on the first direction.

In some embodiments, a width of the lower surface along the first direction is 0.9 mm to 1.6 mm.

In some embodiments, a width of the tip portion along the first direction is 0.3 mm to 0.8 mm.

In some embodiments, a width of the lower surface along the first direction is 1.125 to 5.34 times a width of the tip portion.

In some embodiments, the extension portion further includes: a second corner portion connected to an other end of the lower surface; and a second side surface extending from the second corner portion to the body portion, and facing the first side surface, and wherein the second corner portion is in a form of a curved surface having a curvature.

In some embodiments, a radius of the curvature of the second corner portion is 0.1 mm to 0.9 mm.

In some embodiments, the tip portion includes a plurality of protrusions arranged in at least one row.

In some embodiments, each of the plurality of protrusions has a convexly curved shape.

In some embodiments, a height of each of the plurality of protrusions along the second direction is 0.15 mm to 0.4 mm.

According to some embodiments of the present disclosure, there is provided a welding device including: an anvil on which a lead tab and a strip terminal are arranged to overlap each other; and a welding horn configured to apply ultrasonic waves while pressurizing an overlapping surface of the lead tab and the strip terminal arranged on the anvil, the welding horn including: a body portion extending in a first direction, and an extension portion extending in a second direction crossing the first direction from an end of the body portion, and is configured to pressurize the overlapping surface, the extension portion including: a lower surface facing the overlapping surface, a first corner portion connected to one end of the lower surface and facing the lead tab, a first side surface extending from the first corner portion to the body portion, and a tip portion protruding from the lower surface and contacting the overlapping surface, the tip portion being offset from a center of the lower surface toward the first corner portion.

In some embodiments, the first corner portion is in a form of a curved surface having a curvature.

In some embodiments, a radius of the curvature of the first corner portion is 0.1 mm to 0.5 mm.

In some embodiments, the tip portion is positioned to fit with the first corner portion.

In some embodiments, the tip portion is spaced from the first side surface by 0.1 mm to 0.5 mm along the first direction.

In some embodiments, a width of the lower surface along the first direction is 0.9 mm to 1.6 mm.

In some embodiments, a width of the lower surface along the first direction is 1.125 to 5.34 times a width of the tip portion.

However, aspects and features of the present disclosure are not limited to those described above, and other aspects and features not mentioned will be clearly understood by a person skilled in the art from the detailed description, described below.

### BRIEF DESCRIPTION OF DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is a perspective view showing an example of a secondary battery according to some embodiments of the present disclosure.

FIG. 2 is a diagram showing an example of a welding device according to some embodiments of the present disclosure.

FIG. 3 is an enlarged cross-sectional view showing an example of an extension portion of a welding horn according to some embodiments of the present disclosure.

FIG. 4 is a plan view showing an example of the extension portion of the welding horn according to some embodiments of the present disclosure.

FIG. 5 is a side view showing an example of the extension portion of the welding horn according to some embodiments of the present disclosure.

FIG. 6 is a plan view showing an example in which a lead tab and a strip terminal are welded by the welding device according to some embodiments of the present disclosure.

FIG. 7 is a longitudinal sectional view showing an example in which a lead tab and a strip terminal are welded by the welding device according to some embodiments of the present disclosure.

FIG. 8 is a drawing showing a first comparative example of the welding horn.

FIG. 9 is a drawing showing a second comparative example of the welding horn.

FIG. 10 is a drawing showing a third comparative example of the welding horn.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of” A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified. In this disclosure, the sizes and relative sizes of layers and regions illustrated in the drawings may be exaggerated for clarity of explanation. That is, the sizes illustrated in the drawings are for convenience of understanding only and are not limited thereto. In addition, the same reference numerals throughout the specification indicate the same components.

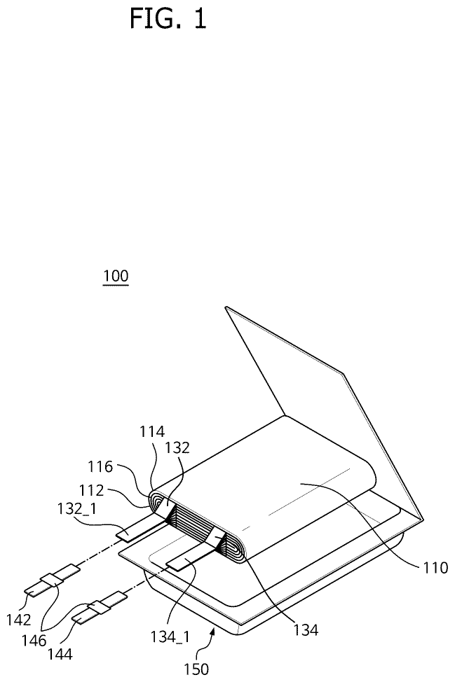

FIG. 1 is a diagram showing an example of a secondary battery (100) according to some embodiments of the present disclosure. The secondary battery (100) shown in FIG. 1 may be a secondary battery manufactured by a welding device according to some embodiments of the present disclosure. As shown, the secondary battery (100) may include a case (150) and an electrode assembly (110) disposed inside the case (150).

The electrode assembly (110) may include a first electrode (112), a second electrode (114), and a separator (116) interposed therebetween. The first electrode (112) and the second electrode (114) may be wound with the separator (116), which is an insulator, interposed therebetween. However, the present invention is not limited thereto, and the electrode assembly (110) may be formed in a structure in which the first electrode (112) and the second electrode (114) made of a plurality of sheets are alternately laminated with the separator (116) interposed therebetween.

The first electrode (112) may contain a first substrate, a first composite part with active material disposed on the first substrate, and a first uncoated part with no active material disposed so that the substrate is exposed. A plurality of first substrate tabs (132) electrically connected to the first uncoated part may be formed on one side of the first electrode (112). Each of the plurality of first substrate tabs (132) may protrude toward a specific location in the electrode assembly (110), and the plurality of first substrate tabs (132) may be connected to form a first lead tab (132_1).

The first lead tab (132_1) may be a current flow path between the first electrode (112) and the first strip terminal (142). A tab film (146) for insulation from the case (150) may be attached to the first strip terminal (142).

The second electrode (114) may contain a second substrate, a second composite part with active material disposed on the second substrate, and a second uncoated part with no active material disposed so that the substrate is exposed. A plurality of second substrate tabs (134) electrically connected to the first uncoated part may be formed on one side of the second electrode (114). Each of the plurality of second substrate tabs (134) may protrude toward a specific location in the electrode assembly (110), and the plurality of second substrate tabs (134) may be connected to form a second lead tab (134_1).

The second lead tab (134_1) may be a current flow path between the second electrode (114) and the second strip terminal (144). A tab film (146) for insulation from the case (150) may be attached to the second strip terminal (144).

The first electrode (112) may function as an anode. In such examples, the first substrate may be composed of, for example, aluminum foil, and the first active material layer may include, for example, a transition metal oxide. The second electrode (114) may function as a cathode. In such examples, the second substrate may be composed of, for example, copper foil or nickel foil, and the second active material layer may include, for example, graphite. In some examples, the first electrode (112) may function as a cathode, and the second electrode (114) may function as an anode.

The separator (116) may function to prevent short circuiting between the first electrode (112) and the second electrode (114) while allowing movement of lithium ions. The separator (116) may be composed of, for example, a polyethylene film, a polypropylene film, a polyethylene-polypropylene film, or the like, but is not limited thereto.

The case (150) may form the overall appearance of the secondary battery (100) and may provide a space in which the electrode assembly (110) is accommodated. An electrolyte may be injected into the case (150) in which the electrode assembly (110) is accommodated. The case (150) may be made of a conductive metal such as aluminum, aluminum alloy, nickel-plated steel, or a laminate film or plastic forming a pouch.

In FIG. 1, the case (150) is shown as a pouch-type case and the secondary battery (100) is shown as a pouch-type secondary battery, but the scope of the present disclosure is not limited thereto. The secondary battery (100) may be a secondary battery of any suitable shape, such as a square shape, a cylindrical shape, a pouch shape, or the like.

In some embodiments, the secondary battery (100) may be a lithium secondary battery, a sodium secondary battery, or the like. However, the scope of the present disclosure is not limited thereto, and the secondary battery (100) may include all batteries that can repeatedly provide electricity by charging and discharging.

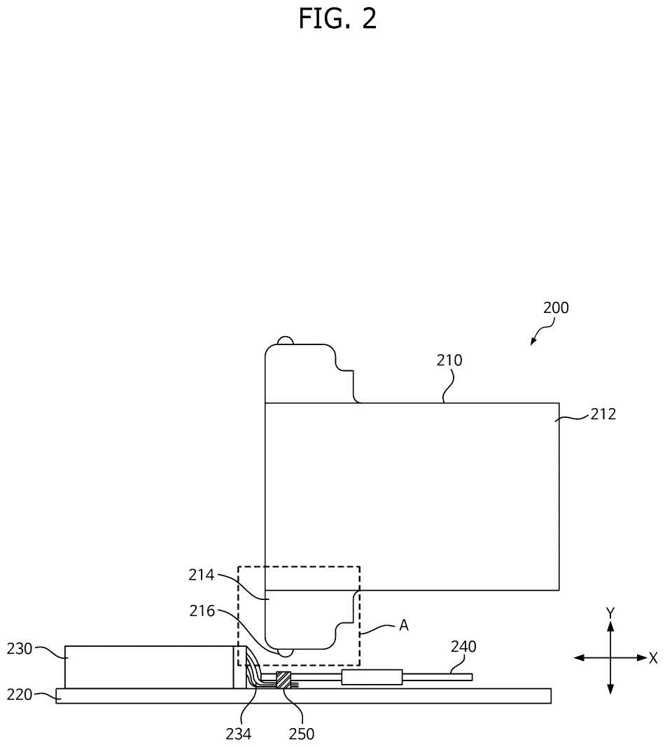

FIG. 2 is a cross-sectional view showing an example of a welding device (200) according to some embodiments of the present disclosure. In some embodiments, the welding device (200) may be a ultrasonic welding device for a secondary battery for welding the welding objects connected to an electrode assembly (230). For example, the welding device (200) may be a device for welding a substrate tab (234) of the electrode assembly (230) and a strip terminal (240).

The welding device (200) may include a welding horn (210) and an anvil (220). For example, on the anvil (220) of the welding device (200), the substrate tab (234) of the electrode assembly (230) and the strip terminal (240) may be disposed in an overlapping state. The welding horn (210) may pressurize the overlapping surface of the substrate tab (234) and the strip terminal (240) disposed on the anvil (220).

The welding horn (210) may include a body portion (212) and an extension portion (214). The body portion (212) may be extended in a first direction (e.g., X-axis) that is approximately parallel to the direction in which the welding objects (e.g., the substrate tab (234) of the electrode assembly (230) and the strip terminal (240)) connected to the electrode assembly (230) are disposed. The extension portion (214) extends from the one end of the body portion (212), and may be extended in the second direction crossing (e.g., intersecting) with the extension direction (e.g., X-axis) of the body portion (212). For example, the second direction may be extended in Y-axis direction that is approximately vertical to the first direction.

In some embodiments, the body portion (212) may transmit ultrasonic waves to the welding object connected to the electrode assembly (230). For example, the body portion (212) may transmit ultrasonic waves to the overlapping surface of the substrate tab (234) and the strip terminal (240). The body portion (212) may be connected to the ultrasonic emitter, or the like, and transmit ultrasonic vibrations to the extension portion (214) connected to the body portion (212). The overlapping surface of the substrate tab (234) and the strip terminal (240) are heated by the vibration energy to a point that they may be welded together.

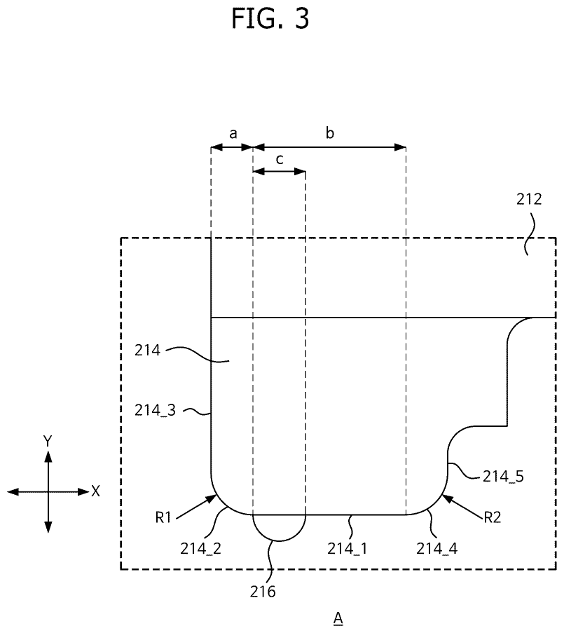

The extension portion (214) of the welding horn (210) may include a tip portion (216). The tip portion (216) may be formed to protrude from the extension portion (214) in a direction facing the welding object. The tip portion (216) may directly contact a welding object connected to the electrode assembly (230). Specific examples of the shapes of the extension portion (214) and the tip portion (216) are described in detail later with reference to FIGS. 3 to 5.

In FIG. 2, two extension portions (214) are shown as extending in the upper and lower directions of the body portion (212) based on the Y-axis, but the number of extension portions (214) and the extension direction of the extension portions (214) are not limited thereto. For example, the welding horn (210) may include only one extension portion (214). In some examples, the welding horn (210) may include four extension portions (214) extending in the up, down, left, and right directions of the body portion (212).

In some embodiments, when the welding horn (210) includes a plurality of extension portions (214), the shape of each of the plurality of extension portions (214) may be different from each other. In addition, when the welding horn (210) includes a plurality of extension portions (214), the shape of the tip portion (216) included in each of the plurality of extension portions (214) may be different from each other.

In some embodiments, the welding device (200) may be a device for manufacturing a thin secondary battery or a small secondary battery applied to a small device. For example, the thickness of the secondary battery manufactured by the welding device (200) may be 3.2 mm or less, and the thickness of the electrode assembly 110 may be 2.7 mm or less. To manufacture these secondary batteries, it is desired to use technology to reduce (e.g., minimize) the portion that does not contribute to the battery capacity in the internal space of the battery. Accordingly, the length of the strip terminal (240) connected to the substrate tab (234) that is bent in the internal space of the battery needs to be reduced. For this purpose, the width of the welding portion (250) where the substrate tab (234) and the strip terminal (240) are welded in an overlapping state also needs to be reduced. For example, the width of the welding portion (250) may be formed to less than approximately 1 mm, and a more precise welding technology is desired to secure a certain level of welding strength in such small area sections.

In the following, an example of a welding device (200) for welding a substrate tab (234) and a strip terminal (240) in the manufacturing process of a miniaturized and thinned secondary battery is described.

FIG. 3 is an enlarged cross-sectional view showing an example of the extension portion (214) of the welding horn according to some embodiments of the present disclosure. FIG. 3 may be a partial enlarged view of the area A shown in FIG. 2. Referring to FIG. 2, the electrode assembly may be disposed on the left side of the extension portion (214) based on the X axis.

In some embodiments, the extension portion 214 may include the lower surface (214_1), the first corner portion (214_2) and the first side surface (214_3). The lower surface (214_1) can be positioned to face the welding object The first corner portion (214_2) is connected to one end of the lower surface (214_1) and may be disposed to face the electrode assembly The first side surface (214_3) may be extended from the first corner portion (214_2) to the body portion (212). The first side surface (214_3) may be extended in the direction that is approximately vertical to the lower surface (214_1).

In some embodiments, the tip portion (216) may protrude on the lower surface (214_1) of the extension portion (214). The tip portion (216) may be extended from the lower surface (214_1) toward the welding object connected to the electrode assembly.

In some embodiments, the first corner portion (214_2) may be in a form of a curved surface having a first curvature (R1). The radius of the first curvature (R1) of the first corner portion (214_2) may be 0.1 mm to 0.5 mm, but is not limited to this.

In some embodiments, the tip portion (216) may be disposed offset toward the first corner portion (214_2) side on the lower surface (214_1). For example, the tip portion (216) may be disposed from the center of the lower surface to the left on the lower surface (214_1). The tip portion (216) may be disposed to be spaced from the first side surface (214_3) by a set or predetermined length (a) or more. In such examples, based on the X-axis direction, the length (a) that the tip portion (216) is spaced from the first side surface (214_3) may be 0.1 mm or more and 0.5 mm or less, but is not limited to this.

In some embodiments, based on the X-axis direction, the width (b) of the lower surface (214_1) may be larger than the width (c) of the tip portion (216). In addition, the width (b) of the lower surface (214_1) may be a certain multiple or more of the width (c) of the tip portion (216). For example, the width (b) of the lower surface (214_1) may be 1.125 to 5.34 times the width (c) of the tip portion (216). In some embodiments, the width (b) of the lower surface (214_1) may be 0.9 mm or more and 1.6 mm or less, but is not limited to this. In some embodiments, the width (c) of the tip portion (216) may be 0.3 mm or more and 0.8 mm or less, but is not limited to this.

In some embodiments, the tip portion (216) may be disposed to be in contact with the first corner portion (214_2). For example, the tip portion 216 may be disposed at a position where the lower surface (214_1) and the first corner portion (214_2) are connected, on the lower surface (214_1). In such examples, the tip portion (216) may be disposed to be spaced from the first side surface (214_3) by a length corresponding to (e.g., substantially equal to) a radius of the first curvature (R1) of the first corner portion (214_2). For example, the length (a) that the tip portion (216) is spaced from the first side surface (214_3) may be 0.1 mm or more and 0.5 mm or less.

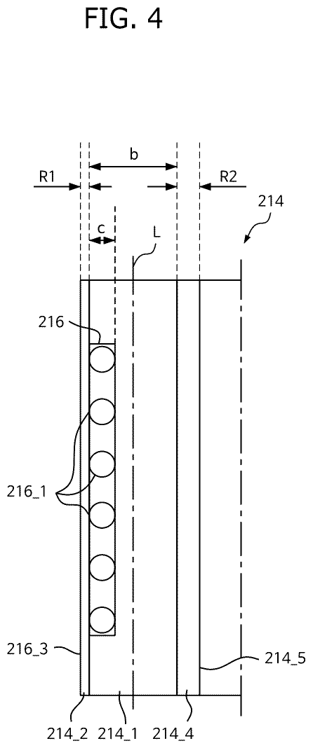

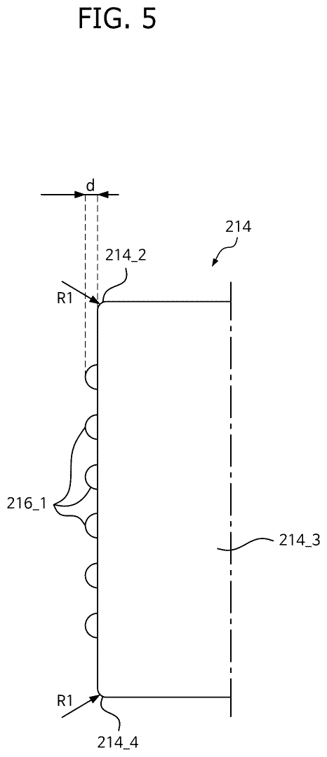

In some embodiments, the tip portion (216) may include a plurality of protrusions. Each of the plurality of protrusions included in the tip portion (216) may have a convexly curved shape. For example, each of the plurality of protrusions may be approximately semicircular. In FIG. 3, the plurality of protrusions included in the tip portion (216) are disposed in one row based on the X-axis direction, but are not limited to this. For example, the plurality of protrusions included in the tip portion (216) may be disposed in a plurality of rows based on the X-axis direction. Specific examples of the forms of the plurality of protrusions included in the tip portion (216) are described in more detail with reference to FIGS. 4 and 5.

In some embodiments, the extension portion 214 may further include the second corner portion (214_4) and the second side surface (214_5). The second corner portion (214_4) may be connected to the other end of the lower surface (214_1) facing the one end of the lower surface (214_1). The second side surface (214_5) may be extended from the second corner portion (214_4) to the body portion (212). The second side surface (214_5) may be extended in the direction that is approximately vertical to the lower surface (214_1).

In some embodiments, the second corner portion (214_4) may be in a form of a curved surface having the second curvature (R2). The radius of the second curvature (R2) of the second corner portion (214_4) may be from 0.1 mm to 0.9 mm, but is not limited to this.

With this configuration, the second corner portion (214_4) connecting the lower surface (214_1) and the second side surface (214_5) is made in a form of a curved surface having the second curvature (R2), thus reducing (e.g., minimizing) damage to the strip terminal or tab film.

Furthermore, the tip portion (216) is disposed offset within a set or predetermined range from the center of the lower surface toward the first corner portion (214_2) side on the lower surface (214_1), so that the welding horn can move as much as possible toward the electrode assembly without interfering with the substrate tab of the electrode assembly.

In addition, by extending the width of the lower surface (214_1) within a set or predetermined multiple range of the width of the tip portion (216) so that the width of the lower surface (214_1) is larger than the width of the tip portion (216), vibration energy can be prevented from being concentrated on the welding object, or the likelihood thereof may be substantially reduced, when the welding horn is lowered. For example, the vibration energy delivered to the tip portion (216) is distributed to the lower surface (214_1), thereby reducing (e.g., minimizing) damage to the welding portion.

In addition, the first corner portion (214_2) connecting the lower surface (214_1) and the first side surface (214_3) is formed in the form of a curved surface having the first curvature (R1), thus reducing (e.g., minimizing) damage to the welding portion.

FIG. 4 is a plan view showing an example of the extension portion (214) of the welding horn according to some embodiments of the present disclosure, and FIG. 5 is a side view showing an example of the extension portion (214) of the welding horn according to some embodiments of the present disclosure. For the convenience of the description, the direction in which the lower surface (214_1) of the extension portion (214) is formed is defined as the lower direction, and the direction in which the first side surface (214_3) is formed is defined as the front direction. FIG. 4 may be a plan view of the extension portion (214) viewed from the lower direction, and FIG. 5 may be a side view of the extension portion (214) viewed from the front direction.

Referring to FIGS. 4 and 5, the extension portion 214 may include a lower surface (214_1), a first corner portion (214_2) connected to one end of the lower surface (214_1), a first side surface (214_3) connected to the first corner portion (214_2), a second corner portion (214_4) connected to the other end of the lower surface (214_1), and a second side surface (214_5) connected to the second corner portion (214_4).

The extension portion (214) may include a tip portion (216) protruding from the lower surface (214_1). Here, the first corner portion (214_2) may be in a form of a curved surface having the first curvature (R1), and the second corner portion (214_4) may be in a form of a curved surface having the second curvature (R2). In addition, the radius of the first curvature (R1) may be 0.1 or more and 0.5 mm or less, and the radius of the second curvature (R2) may be 0.1 or more and 0.9 mm or less, but is not limited to this.

The tip portion (216) may be disposed offset from the center of the lower surface (214_1) toward the first corner portion (214_2) side on the lower surface (214_1). For example, the distance between the tip portion (216) and the first corner portion (214_2) may be greater than the distance between the tip portion (216) and the second corner portion (214_4).

In some embodiments, the tip portion (216) may be disposed to be in contact with the first corner portion (214_2). In such examples, the tip portion (216) may be disposed to be spaced from the first side surface (214_3) by a length corresponding to (e.g., substantially equal to) a radius of the first curvature (R1) of the first corner portion (214_2). For example, the length that the tip portion (216) is spaced from the first side surface (214_3) may be 0.1 mm or more and 0.5 mm or less.

In some embodiments, the width (b) of the lower surface (214_1) may be larger than the width (c) of the tip portion (216). For example, the width (b) of the lower surface (214_1) may be 1.125 to 5.34 times the width (c) of the tip portion (216). In some embodiments, the width (b) of the lower surface (214_1) may be 0.9 mm or more and 1.6 mm or less, but is not limited to this. In some embodiments, the width (c) of the tip portion (216) may be 0.3 mm or more and 0.8 mm or less, but is not limited to this.

In some embodiments, the tip portion (216) may include a plurality of protrusions (216_1). Each of the plurality of protrusions (216_1) included in the tip portion (216) may have a convexly curved shape. For example, each of the plurality of protrusions (216_1) may be approximately semicircular. Accordingly, it is possible to prevent the protrusions (216_1) from causing damage to the welding object, or substantially reduce the likelihood thereof, while contacting the welding object.

In some embodiments, the plurality of protrusions (216_1) included in the tip portion (216) may be arranged in at least one row along the longitudinal direction of the lower surface (214_1). As a specific example, the plurality of protrusions (216_1) included in the tip portion (216) may be arranged in one row along the longitudinal direction of the lower surface (214_1). In such examples, the width of each of the plurality of protrusions (216_1) may correspond to the width (c) of the tip portion (216). For example, the width of each of the plurality of protrusions (216_1) may be 0.3 mm or more and 0.8 mm or less, but is not limited to this. As another example, the plurality of protrusions (216_1) included in the tip portion (216) may be arranged in a plurality of rows along the longitudinal direction of the lower surface (214_1). In such examples, the width of each of the plurality of protrusions (216_1) may be proportionally reduced to correspond to the width of the tip portion (216).

In some embodiments, the height (d) of each of the plurality of protrusions (216_1) may be 0.15 mm to 0.4 mm. When the height (d) of each of the plurality of protrusions (216_1) is less than 0.15 mm, the life of the welding horn may be shortened by the wear of the protrusion. When the height (d) of each of the plurality of protrusions (216_1) exceeds 0.4 mm, the welding quality may be reduced.

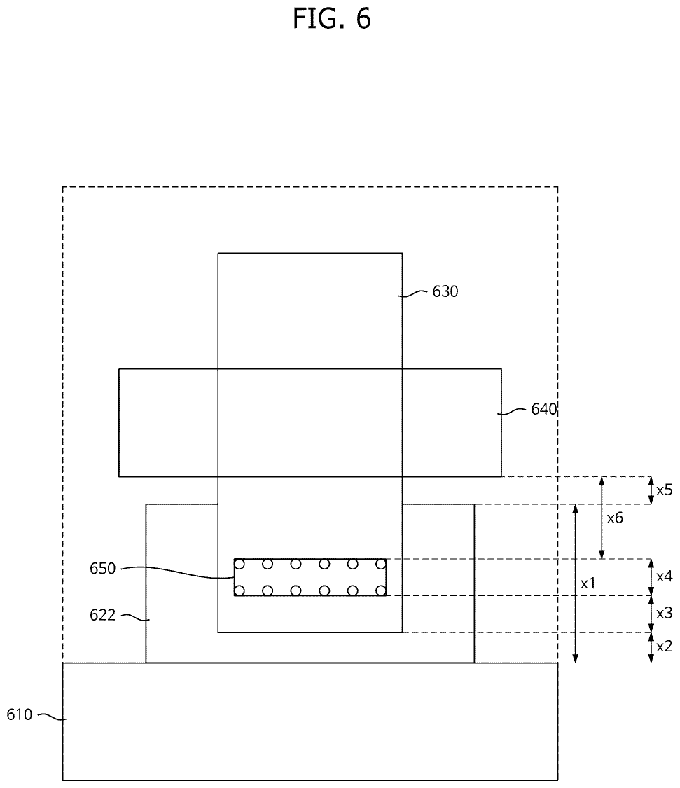

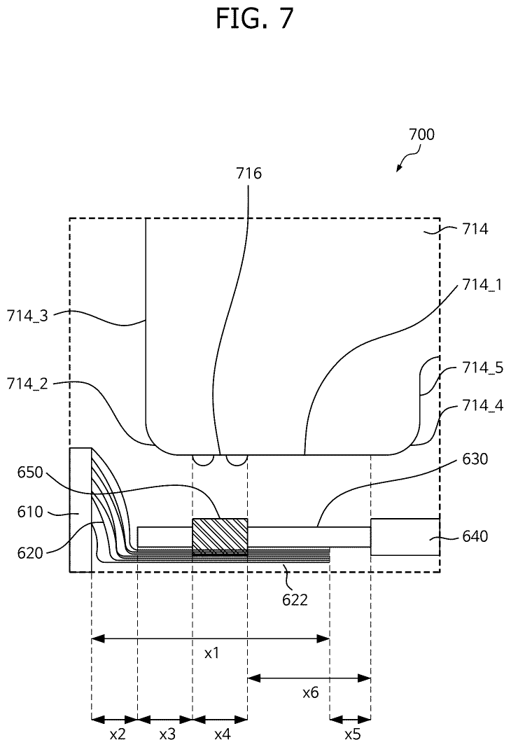

FIG. 6 is a plan view showing an example in which a lead tab (622) and a strip terminal (630) are welded by a welding device (700) according to some embodiments of the present disclosure, and FIG. 7 is a longitudinal sectional view showing an example in which the lead tab (622) and the strip terminal (630) are welded by the welding device (700) according to some embodiments of the present disclosure.

Referring to FIG. 6, a separator (610) may protrude from one side of the electrode assembly. The electrode assembly may be configured such that a first electrode, a second electrode, and a separator (610) interposed between the first electrode and the second electrode are alternately laminated, and the separator (610) may protrude further than the first electrode and the second electrode in the electrode assembly to prevent or substantially reduce the likelihood of contact between the first electrode and the second electrode.

In some embodiments, the lead tab (622) may protrude from one side of the electrode assembly. For example, on one side of the electrode assembly, a plurality of substrate tabs (620) are protruded at specific positions, and the plurality of substrate tabs (620) may be connected together to form the lead tab (622). The lead tab (622) may protrude further than the separator (610). The lead tab (622) may protrude by a first length (x1) from the separator (610). Here, the first length (x1) may be 1.3 mm to 1.8 mm, but is not limited to this. The lead tab (622) and the substrate tab (620) may correspond to separate configurations. In some examples, some of the substrate tabs (620) may be used as the lead tabs (622).

In some embodiments, the lead tab (622) may be connected to the strip terminal 630. For example, the strip terminal (630) may be disposed to overlap with the lead tab (622). In addition, the strip terminal (630) may be disposed to be spaced from the separator (610) by the second length (x2). Here, the second length (x2) may be about 0.4 mm, but is not limited to that.

In some embodiments, the lead tab (622) and the strip terminal (630) may be welded in an overlapping state. Accordingly, a welding portion (650) may be formed on the overlapping surface of the lead tab (622) and the strip terminal (630). The welding portion (650) may be formed at a position spaced from the end of the strip terminal (630) by the third length (x3). Here, the third length (x3) may be 0.3 mm to 0.5 mm, but is not limited to this. In addition, the width of the welding portion (650) may be formed in the fourth length (x4). Here, the fourth length (x4) may be 0.3 mm to 0.8 mm, but is not limited to this.

In some embodiments, a tab film (640) for insulation from the case (150) may be attached to the strip terminal (630). The tab film (640) may be attached at a position spaced from the lead tab (622) by the fifth length (x5). Here, the fifth length (x5) may be about 0.3 mm, but is not limited to that. In addition, the tab film (640) may be attached at a position spaced from the welding portion (650) by the sixth length (x6). Here, the sixth length (x6) may be 0.6 mm to 0.8 mm, but is not limited to this.

Referring to FIG. 7, it may be seen how the lead tab (622) and the strip terminal (630) are welded by the extension portion (714) formed in the welding horn of the welding device (700). The extension portion (714) may pressurize a welding object connected to the electrode assembly (e.g., the lead tab (622) and the strip terminal (630) of the electrode assembly).

In some embodiments, the extension portion (714) may include a lower surface (714_1), a first corner portion (714_2) connected to one end of the lower surface (714_1), a first side surface (714_3) connected to the first corner portion (714_2), a second corner portion (714_4) connected to the other end of the lower surface (714_1), a second side surface (714_5) connected to the second corner portion (714_4), and a tip portion (716) protruding from the lower surface (714_1).

In some embodiments, the width of the tip portion (716) may correspond to the fourth length (x4) which is the width of the welding portion (650). For example, the width of the tip portion (716) may be 0.3 mm to 0.8 mm, but is not limited to this.

In some embodiments, the distance that the tip portion (716) is spaced from the first side surface (714_3) may be equal to or less than the third length (x3), which is the distance that the welding portion (650) is spaced from the end of the strip terminal (630). For example, the distance that the tip portion (716) is spaced from the first side surface (714_3) may be less than 0.3 mm to 0.5 mm, which is the third length (x3). For example, the distance that the tip portion (716) is spaced from the first side surface (714_3) may be 0.1 mm to 0.5 mm, but is not limited to this. By using this configuration, the extension portion (714) may be prevented from coming into contact with the substrate tab (620), or the likelihood thereof may be substantially reduced. For example, in the process of forming the lead tab (622) by connecting a plurality of substrate tabs (620), lifting may occur due to a difference in position between the plurality of substrate tabs (620). In such examples, the lifting phenomenon of the substrate tab (620) may mainly occur in the space between the strip terminal (630) and the separator (610). In other words, by ensuring that the first side surface (714_3) of the extension portion (714) does not protrude beyond the end of the strip terminal (630), damage to the substrate tab (620) due to interference with the extension portion (714) can be prevented or substantially reduced.

In some embodiments, the tip portion (716) may be disposed on the lower surface (714_1) to be in contact with the first corner portion (714_2). In other words, the tip portion (716) may be disposed on the lower surface (714_1), with a minimum distance from the first side surface (714_3). Accordingly, the third length (x3), which is the distance that the welding portion (650) is spaced from the end of the strip terminal (630), is reduced (e.g., minimized) so that the welding portion (650) may be formed as close as possible to the electrode assembly.

In some embodiments, the width of the lower surface (714_1) of the extension portion (714) may be shorter than or equal to the combined length of the fourth length (x4) and the sixth length (x6). For example, the fourth length (x4) may be 0.3 mm to 0.8 mm, the sixth length (x6) may be 0.6 mm to 0.8 mm, and the width of the lower surface (714_1) may be 0.9 mm to 1.6 mm, but are not limited to this. Accordingly, the lower surface (714_1) of the extension portion (714) may be extended only to a position where the lower surface (714_1) does not interfere with the tab film (640).

In some embodiments, the width of the lower surface (714_1) may be 1.125 to 5.34 times the width of the tip portion (716). For example, the width of the lower surface (714_1) may be 0.9 mm to 1.6 mm, and the width of the tip portion (716) may be 0.3 mm to 0.8 mm. Accordingly, the vibration energy delivered to the tip portion (716) is distributed to the lower surface (714_1), thereby preventing cracking in the welding portion (650).

In some embodiments, the first corner portion (714_2) of the extension portion (714) may be in a form of a curved surface having a curvature. As the first corner portion (714_2) is configured in a curved shape rather than an angled shape, it is possible to prevent the first corner portion (714_2) from causing damage to the strip terminal (630), or substantially reduce the likelihood thereof, while contacting the strip terminal (630).

In some embodiments, the second corner portion (714_4) of the extension portion (714) may be in a form of a curved surface having a curvature. As the second corner portion (714_4) is configured in a curved shape rather than an angled shape, it is possible to prevent the second corner portion (714_4) from causing damage to the strip terminal (630) or tab film (640), or substantially reduce the likelihood thereof, while contacting the strip terminal (630) or tab film (640).

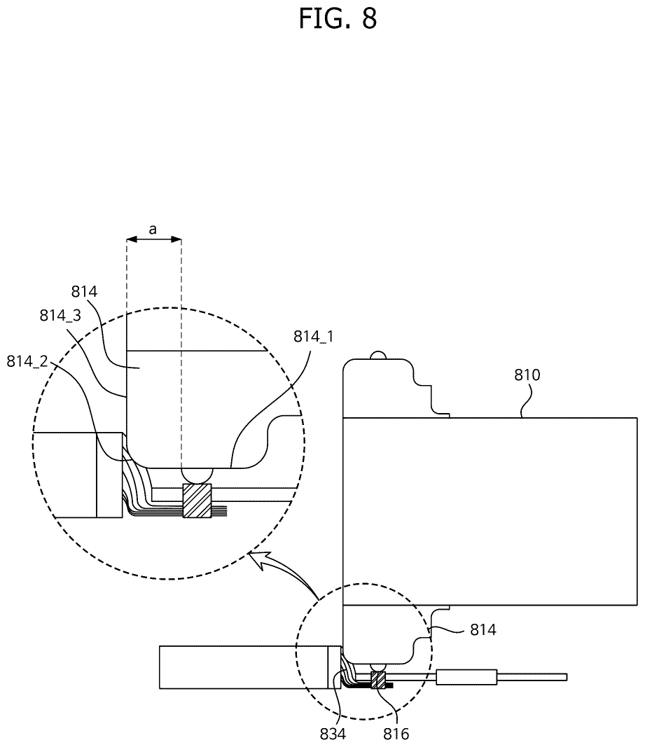

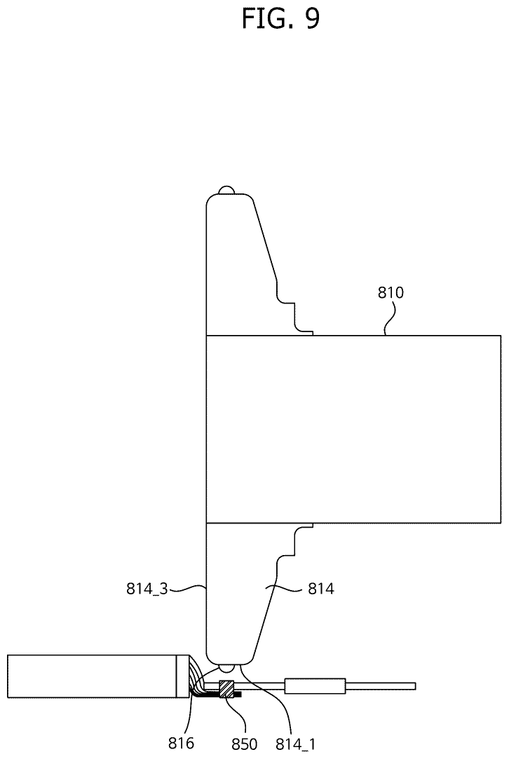

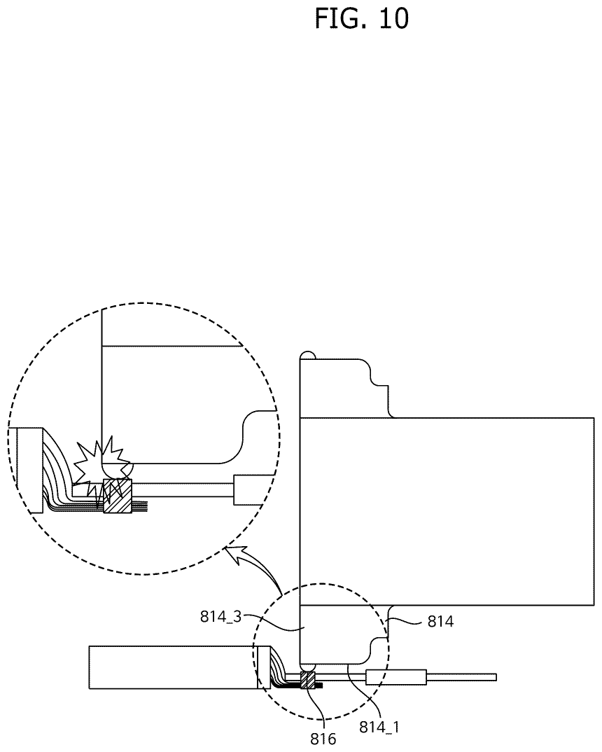

FIG. 8 is a drawing showing a first comparative example of the welding horn, FIG. 9 is a drawing showing a second comparative example of the welding horn, and FIG. 10 is a drawing showing a third comparative example of the welding horn. In FIGS. 8 to 10, previously described or duplicated configurations are omitted.

Referring to FIG. 8, the welding horn (810) includes an extension portion (814) facing the welding object connected to the electrode assembly, and a tip portion (816) may be formed on the lower surface (814_1) of the extension portion (814). The tip portion (816) may be disposed to be spaced from the first side surface (814_3) of the extension portion (814). In such examples, when the tip portion (816) is not positioned so as to be offset from the center of the lower surface toward the first corner portion and the length (a) that the tip portion (816) is spaced from the first side surface (814_3) is greater than a certain length, the extension portion (814) may interfere with the substrate tab (834), causing the substrate tab (834) to be damaged.

Referring to FIG. 9, when compared to the first comparative example of FIG. 8, it may be observed that the length of the lower surface (814_1) of the extension portion (814) is reduced. In such examples, the problem of the extension portion (814) interfering with the substrate tab (834) may be partially resolved, and as the width of the extension portion (814) is reduced overall, entry into the welding section may be facilitated. However, when the width of the lower surface (814_1) of the extension portion (814) is not formed to be more than a set or predetermined multiple of the width of the tip portion (816), the tip portion (816) is displaced at the center of the lower surface, so that vibration energy is concentrated on the tip portion (816), and cracks may occur in the welding portion (850).

Referring to FIG. 10, when compared with the first comparative example in FIG. 8, the first corner portion (814_2) connecting the lower surface (814_1) and the first side surface (814_3) of the extension portion (814) is deleted, and the tip portion (816) is disposed to be in contact with the first side surface (814_3). In such examples, the welding portion (850) may be formed at a distance as close as possible to the electrode assembly, and the phenomenon of vibration energy being concentrated on the tip portion (816) can also be prevented or substantially reduced. However, when a curved surface is not formed between the first side surface (814_3) and the tip portion (816), the surface of the welding object may be damaged by the corner portion where the first side surface (814_3) and the tip portion (816) are connected.

Based on comparative examples of FIGS. 8 to 10, the shape of the welding horn may be optimized. For example, to prevent or substantially reduce the extension portion (814) of the welding horn from interfering with the substrate tab (834), the tip portion (816) may be disposed to be spaced from the first side surface (814_3) by 0.1 mm to 0.5 mm. In addition, to prevent or substantially reduce the concentration of vibration energy on the tip portion (816), the width of the lower surface (814_1) of the extension portion (814) may be 1.125 or 5.34 times the width of the tip portion (816). In addition, to prevent or substantially reduce damage to the surface of the welding object, the first corner portion (814_2) of a curved shape having a set or predetermined curvature may be disposed at a position where the lower surface (814_1) and the first side surface (814_3) of the extension portion (814) are connected.

Through this configuration, by optimizing the shape of the welding horn, the width of the welding portion of the substrate tab (834) and the strip terminal, which does not contribute to the battery capacity, can be reduced (e.g., minimized), thereby manufacturing a miniaturized and thin secondary battery with high energy density.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

### DESCRIPTION OF SOME OF THE REFERENCE SYMBOLS

100: Secondary battery

110: Electrode assembly

112: First electrode

114: Second electrode

116: Separator

132: First substrate tab

132_1: First lead tab

134: Second substrate tab

134_1: Second lead tab

142: First strip terminal

144: Second strip terminal

146: tab film

150: Case

What is claimed is:

1. A welding horn comprising:
a body portion extending in a first direction; and
an extension portion extending in a second direction crossing the first direction from an end of the body portion, and is configured to pressurize a welding object connected to an electrode assembly, the extension portion comprising:
a lower surface facing the welding object;
a first corner portion connected to one end of the lower surface and facing the electrode assembly;
a first side surface extending from the first corner portion to the body portion; and
a tip portion protruding from the lower surface and contacting the welding object, the tip portion being offset from a center of the lower surface toward the first corner portion.

2. The welding horn according to claim 1, wherein the first corner portion is in a form of a curved surface having a curvature.

3. The welding horn according to claim 2, wherein a radius of the curvature of the first corner portion is 0.1 mm to 0.5 mm.

4. The welding horn according to claim 3, wherein the tip portion is positioned to be in contact with the first corner portion.

5. The welding horn according to claim 1, wherein the tip portion is spaced from the first side surface by 0.1 mm to 0.5 mm, based on the first direction.

6. The welding horn according to claim 1, wherein a width of the lower surface along the first direction is 0.9 mm to 1.6 mm.

7. The welding horn according to claim 1, wherein a width of the tip portion along the first direction is 0.3 mm to 0.8 mm.

8. The welding horn according to claim 1, wherein a width of the lower surface along the first direction is 1.125 to 5.34 times a width of the tip portion.

9. The welding horn according to claim 1, wherein the extension portion further comprises:
a second corner portion connected to an other end of the lower surface; and
a second side surface extending from the second corner portion to the body portion, and facing the first side surface, and
wherein the second corner portion is in a form of a curved surface having a curvature.

10. The welding horn according to claim 9, wherein a radius of the curvature of the second corner portion is 0.1 mm to 0.9 mm.

11. The welding horn according to claim 1, wherein the tip portion comprises a plurality of protrusions arranged in at least one row.

12. The welding horn according to claim 11, wherein each of the plurality of protrusions has a convexly curved shape.

13. The welding horn according to claim 11, wherein a height of each of the plurality of protrusions along the second direction is 0.15 mm to 0.4 mm.

14. A welding device comprising:
an anvil on which a lead tab and a strip terminal are arranged to overlap each other; and
a welding horn configured to apply ultrasonic waves while pressurizing an overlapping surface of the lead tab and the strip terminal arranged on the anvil, the welding horn comprising:
a body portion extending in a first direction; and
an extension portion extending in a second direction crossing the first direction from an end of the body portion, and is configured to pressurize the overlapping surface, the extension portion comprising:
a lower surface facing the overlapping surface;
a first corner portion connected to one end of the lower surface and facing the lead tab;
a first side surface extending from the first corner portion to the body portion; and
a tip portion protruding from the lower surface and contacting the overlapping surface, the tip portion being offset from a center of the lower surface toward the first corner portion.

15. The welding device according to claim 14, wherein the first corner portion is in a form of a curved surface having a curvature.

16. The welding device according to claim 15, wherein a radius of the curvature of the first corner portion is 0.1 mm to 0.5 mm.

17. The welding device according to claim 14, wherein the tip portion is positioned to fit with the first corner portion.

18. The welding device according to claim 14, wherein the tip portion is spaced from the first side surface by 0.1 mm to 0.5 mm along the first direction.

19. The welding device according to claim 14, wherein a width of the lower surface along the first direction is 0.9 mm to 1.6 mm.

20. The welding device according to claim 14, wherein a width of the lower surface along the first direction is 1.125 to 5.34 times a width of the tip portion.
